(19) United States
(12) Patent Application Publication
(10) Pub. No.: US 2021/0372448 A1
(43) Pub. Date: Dec. 2, 2021

(54) COMBINING AND EXPANDING STRUCTURE OF LAYERED FRAME

(71) Applicant: MATTHEW COMFORT CO., LTD., CHANGHUA HSIEN (TW)

(72) Inventor: Chieh-Hung YANG, CHANGHUA HSIEN (TW)

(21) Appl. No.: 16/888,656

(22) Filed: May 29, 2020

(51) Int. Cl. F16B 12/32; F16B 12/44

(52) U.S. Cl. CPC F16B 12/32; F16B 12/38; F16B 12/44

(57) ABSTRACT

The present invention provides a combining and expanding structure of a layered frame, especially to provide a design of a combining hook of a layer plate of the layered frame for allowing the layered frame to be easily combined in a coupled or multiplied format; a combining part of the combining hook is designed to be formed in various structural statuses with respect to the layer plate made of different materials and formed in different statuses, so that the combining hook is able to be respectively combined at four distal corner parts of a metal-state layer plate, an iron-rod layer plate, a wooden-state layer plate or a glass-state layer plate, a buckling hook part of the combining hook is designed in a half-thickness status, so that the combining hooks disposed at the left and the right distal corner parts of the layer plate are able to be oppositely arranged.

### BACKGROUND OF THE INVENTION

### Field of the Invention

The present invention relates to a combining and expanding structure of a layered frame, with a novel design of a combining hook respectively combined at four distal corner pars of a layer plate, when a requirement of expanding the specification of the layered frame, only a single-rod lateral frame is needed for finishing an combining and expanding operation of the layered frame, instead of a dual-rod lateral frame, so that advantages of being more practical and flexible in use are provided.

### Description of Related Art

For satisfying various interior designs of an office and domestic space designs, a conventional fixed furniture often causes a problem of being limited for the arrangement due to the limited internal space, for solving this problem, an assembled type or a specified assembled type furniture has been developed for meeting the requirement of freely adjusting the arrangement, so that the furniture can be more flexibly arranged in terms of space layout.

There are several types of assembled layered frames available in the market, for example being made of wood, plastic or metal, wherein the metal-made assembled layered frame is expensive but still draws a lot of consumers' attentions because it is strong and durable, so that the metal-made assembled layered frame is popular in this market sector.

In the conventional assembled layered frame, screw bolts are often utilized for locking the layer plate and the frame rack with a fastening means, or pipe sleeves are provided at distal corner parts of the layer plate which work with positioning adhesive sleeves provided on posts of the frame body, thereby achieving an effect of sleeving and positioning, the above-mentioned fastening means is able to allow the metal layer plate to be combined with the posts of the frame body; however, the assembling procedure is complicated and labor consuming, when the amount of layer plates and the intervals are desired to be adjusted, more inconveniences are caused, and the whole assembly may even have to be detached then reassembled again; as such, the aforesaid disadvantages shall be improved; moreover, the conventional layered frame cannot be combined for expansion, thus the practicability is very much limited, as such, the above-mentioned disadvantage shall be improved.

In view of the above-mentioned disadvantages, the applicant of the present invention has developed an assembled metal layered frame, in which four distal corner parts of a metal layer plate are provided with combining hooks which work with a dual-rod frame rod for being mutually buckled and combined for finishing the whole assembly, with the structural design of the combining hook, there is no need of screw bolt when the layer plate is combined with the frame rod, and there is also no requirement of detaching the whole assembly when an adjustment is desired, so that functions of flexibly adjusting the amount of layer plates and the intervals can be provided; meanwhile, the amount of frame rods can be increased with respect to the actual needs for a purpose of being horizontally expanded.

However, when the above-mentioned layered frame is desired to be horizontally expanded, the dual-rod frame rod has to be provided as a combining interface for two lateral frames, thus the plate layers at two sides can be respectively provided with individual posts for being buckled and combined without being interfered with each other or affecting the combination, as such, the assembly is limited and the dual-rod frame rod would cause unnecessary assembling cost of the whole structure; accordingly, a novel design having a better economic benefit shall be provided for solving the above-mentioned disadvantages.

### SUMMARY OF THE INVENTION

In view of the problems and disadvantages caused by the layer plate of the conventional metal layered frame and the combining hook of the post in terms of being combined for a purpose of expansion, the applicant of the present invention has devoted himself to design a combining and expanding structure of a layered frame.

Accordingly, one primary objective of the present invention is to provide a combining and expanding structure of a layered frame; for achieving the objective of combining and expanding the layered frame, a combining part of a combining hook is designed to be formed in various structural statuses with respect to a layer plate made of different materials and formed in different statuses, so that the combining hook is able to be respectively combined at four distal corner parts of a metal-state layer plate, an iron-rod layer plate, a wooden-state layer plate or a glass-state layer plate, a buckling hook part of the combining hook is designed in a half-thickness status, so that when the combing hook is respectively combined at the four distal corner parts of the layer plate, the combining hooks disposed at the left and the right distal corner parts of the layer plate are able to be oppositely arranged, thus under a principle of not affecting the existed assembling operation and usage functions of the layered frame, when specification of the layered frame is desired to be expanded, only one set of lateral frame is required for enabling the desired layer plate to be buckled and assembled between the lateral frame of the existing layered frame and the new lateral frame, and the buckling hook parts of the combining hooks of the adjacent layer plates can be complementarily stacked, thereby achieving the objective of combining and expanding the layered frame.

According to the combining and expanding structure of the layered frame provided by the present invention, with the buckling hook part of the combining hook respectively combined at the four distal corner parts of the layer plate being designed in the half-thickness status, the combining part of the combining hook can be designed with respect to different assembling statuses of the layer plates made of different materials, the combining hooks arranged at the left side and the right side of the layer plate are oppositely arranged, so that when a requirement of the layered frame being desired to be horizontally expanded and combined, the operation of combining and expanding the layered frame can be easily finished through additionally providing a set of frame rods and a plurality of layer plates, and the existed assembling relation and the operation status of the layered frame are totally prevented from being affected; as such, the combining and expanding structure of the layered frame provided by the present invention is novel and more practical in use comparing to prior art.

### BRIEF DESCRIPTION OF THE DRAWINGS

FIG. 1 is a schematic view showing the whole structure according to a preferred embodiment of the present invention;

FIG. 2 is a partially exploded view showing the structure according to the first embodiment of the present invention;

FIG. 3 is a partially exploded view according to the first embodiment of the present invention;

FIG. 4 is a partial view showing the assembly according to the first embodiment of the present invention;

FIG. 5 is a partially planar and exploded view according to the first embodiment of the present invention;

FIG. 6 is a partially planar view showing the assembly according to the first embodiment of the present invention;

FIG. 7 is a partially exploded view according to the second embodiment of the present invention;

FIG. 8 is a partially exploded view according to the third embodiment of the present invention;

FIG. 9 is a partially exploded view according to the fourth embodiment of the present invention;

FIG. 10 is a partially exploded view according to the fifth embodiment of the present invention; and

FIG. 11 is a partially exploded view according to the sixth embodiment of the present invention.

### DETAILED DESCRIPTION OF THE PREFERRED EMBODIMENT

The structural assembly, the technical means and effects of preferred embodiments of the present invention will be described with reference to the drawings.

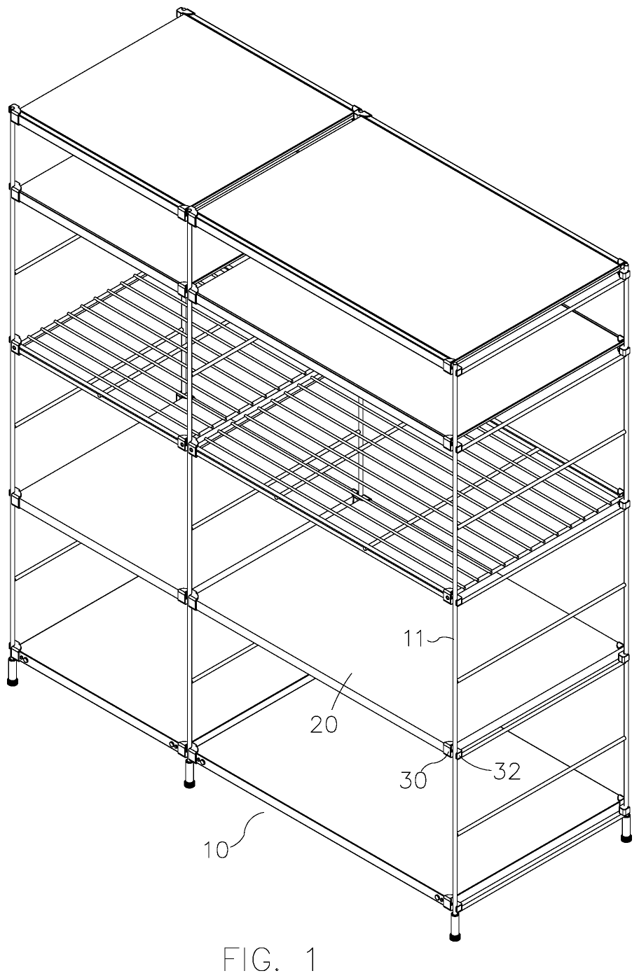

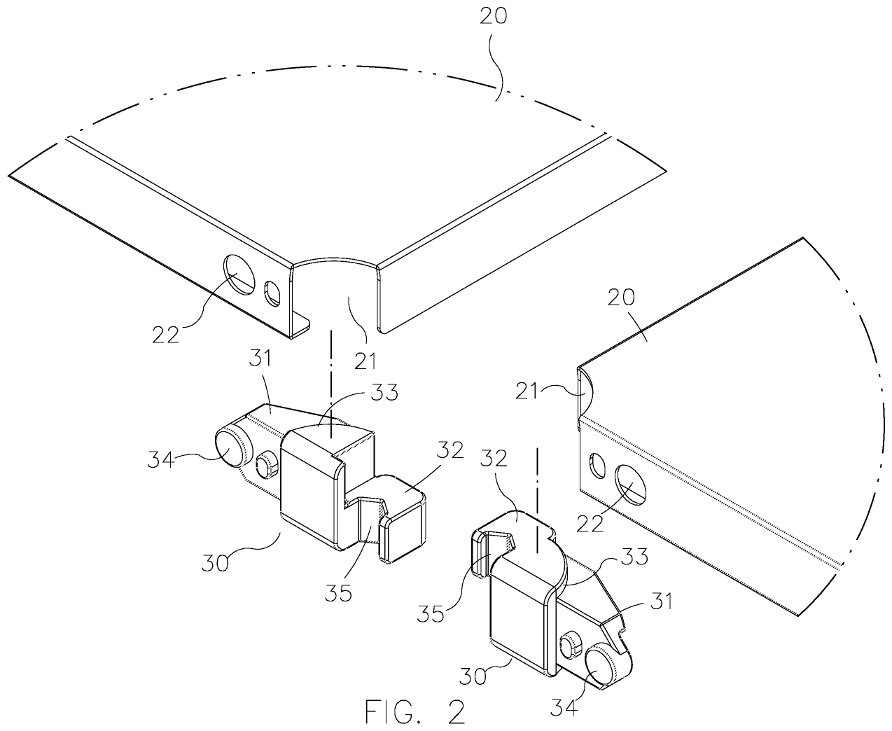

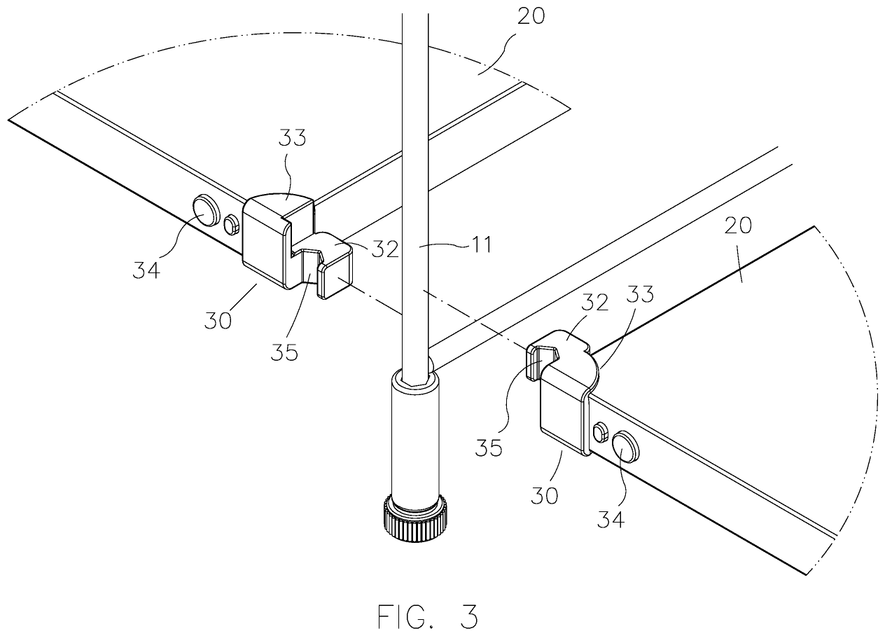

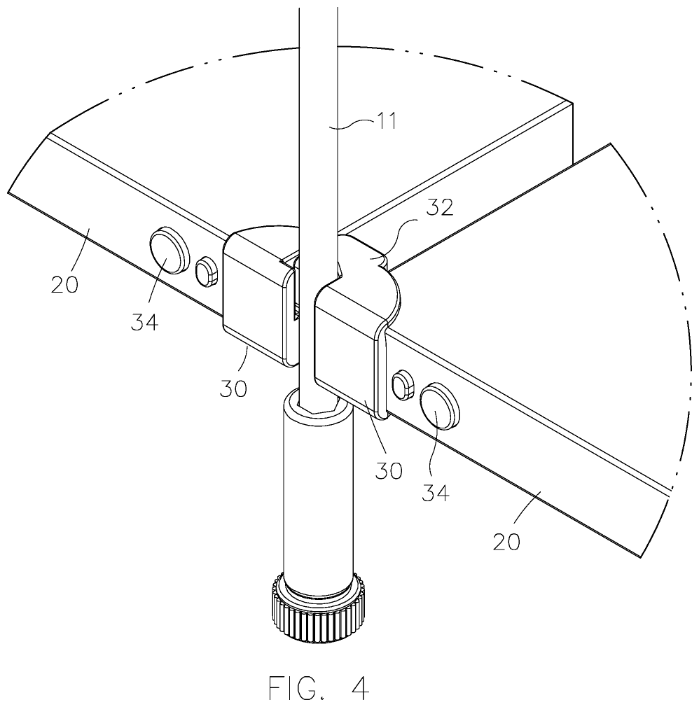

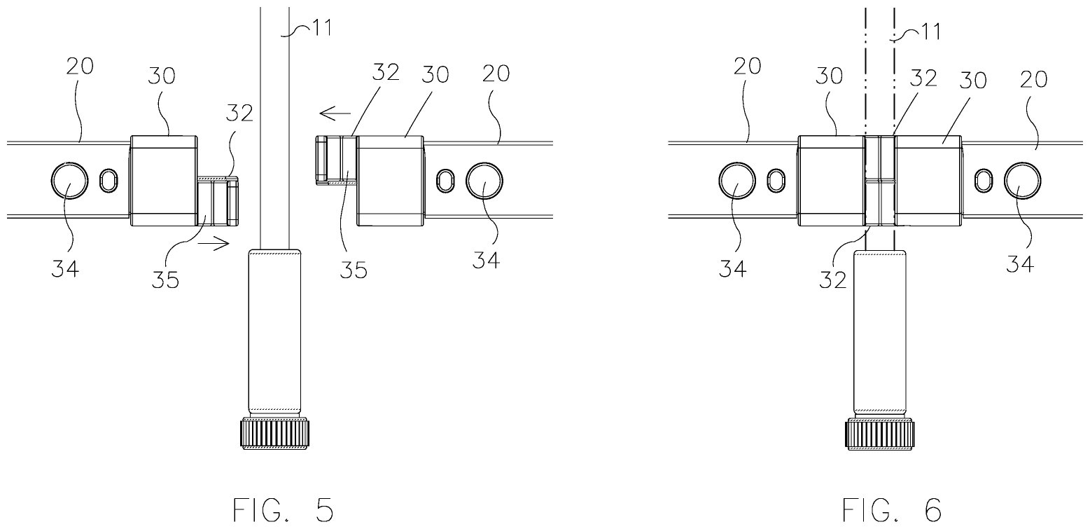

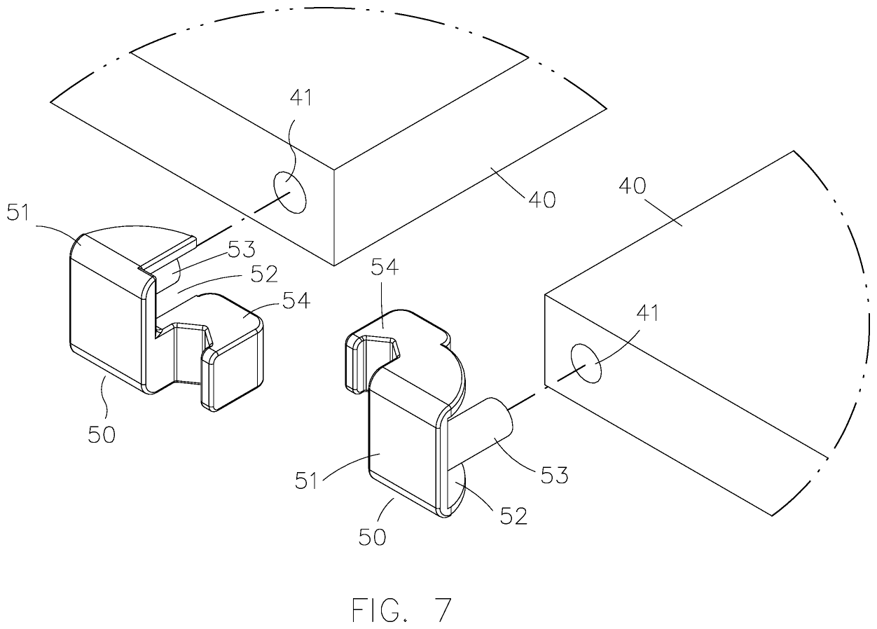

Referring from FIG. 1 to FIG. 6, according to the first embodiment of the present invention, a combining and expanding structure of a layered frame is disclosed; as shown in figures, a horizontal combining and expanding function is provided according to the present invention with increasing the manufacturing cost of a frame rod, so that a frame rod (11) of the layered frame (10) is still designed in a single-rod status, and in a design for matching with a layer plate (20), various types of a combing hook (30) is provided with respect to the material and the status of the layer plate (20); according this embodiment of the present invention, the combining hook (30) is designed for matching with an assembled metal-plate layer plate (20), the combining hook (30) is consisted of a combining part (31) capable of being respectively mounted at four distal corner parts of the layer plate (20), and buckling hook part (32) integrally extended from one side of the combing part (31); the combining part (31) has an abutting parts (33) engaged at a top edge and a bottom edge of a base part of the buckling hook part (32) and capable of matching and abutting against four distal corner arc-shaped notches (21) of the layer plate (20), so as to achieve a stably fastening effect, an outer circumference of the combining part (31) is formed with convex mounting columns (34) (one of which being in a large status, and the other being in a small status as shown in figures, but an arrangement thereof can be altered according to actuals need) corresponding to penetrated holes (22) preformed on a lateral surface defined on one distal corner part of the layer plate (20), with the convex mounting columns (34) working with the abutting part (33), the combining part (30) is able to be stably combined at the four distal corner parts of the layer plate (20); for meeting a requirement of combining the layer plate (20), the buckling hook part (32) of the combining hook (30) is formed in a half-thickness status, meanwhile, a hook slot (35) is formed in a non-arched polygonal status with respect to the dimension of the frame rod (11) of the layered frame (10), so that when the combining hook (30) is assembled at the four distal corner parts of the layer plate (20), the combining hooks (30) at the left and the right distal corner parts are oppositely arranged, the buckling hook parts (32) of the combining hooks (30) are in status of the left being higher than the right, or the right being higher than the left; as such, under a principle of not affecting the existed assembling operation and usage functions of the layered frame (10), when the horizontal specification of the layered frame (10) is desired to be expanded, only one set of frame rod (11) disposed at one side is required for enabling the desired layer plate (20) to be buckled and assembled between the side frame rod (11) of the existing layered frame (10) and the new side frame rod (11), and the buckling hook parts (32) of the combining hooks (30) of the adjacent layer plates (20) are able to be mutually stacked, thereby achieving a combining and expanding effect of the layered frame (10).

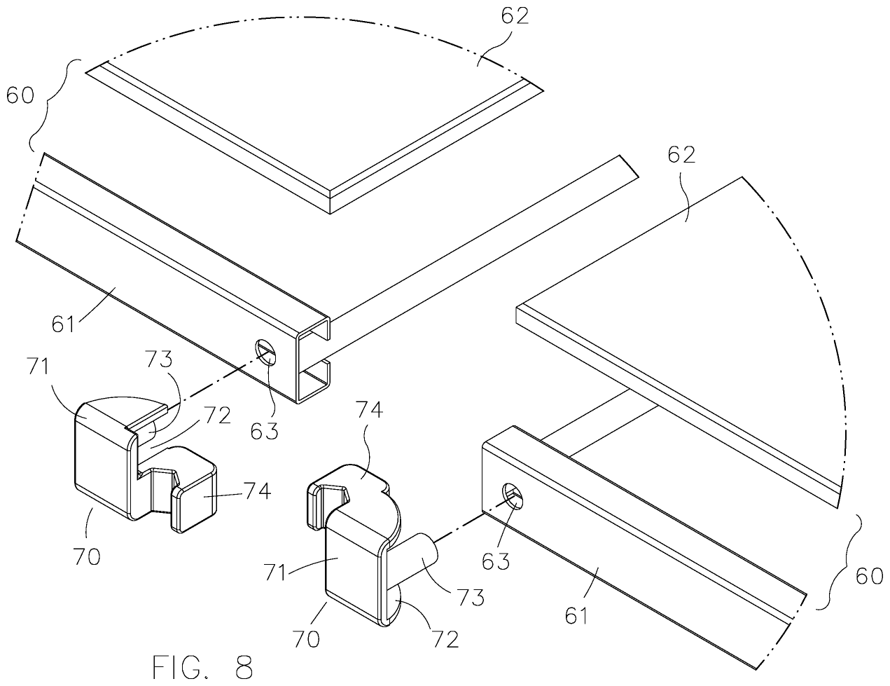

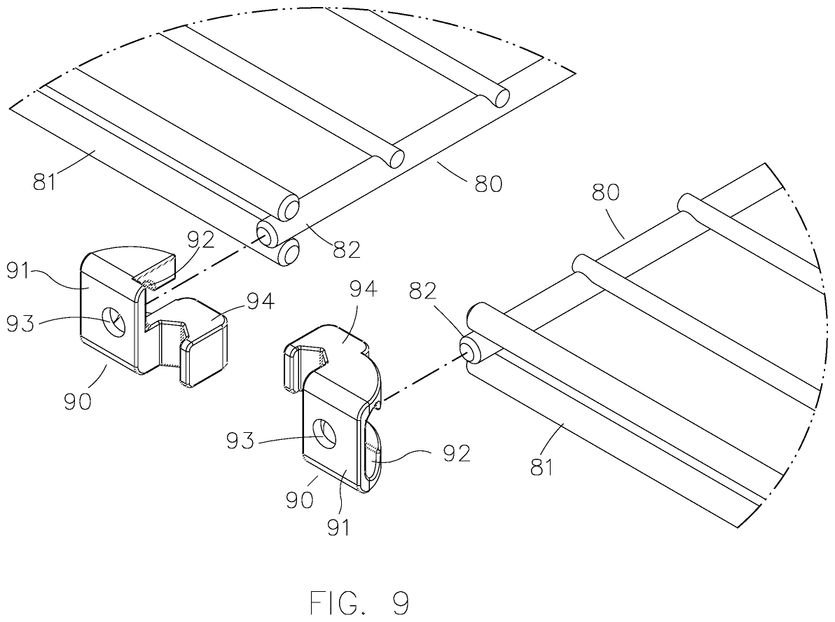

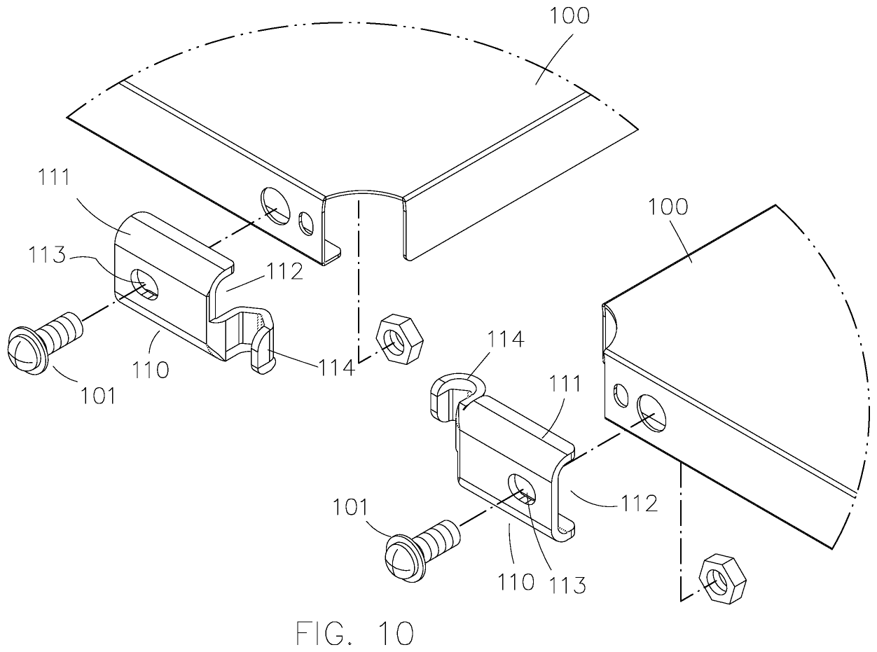

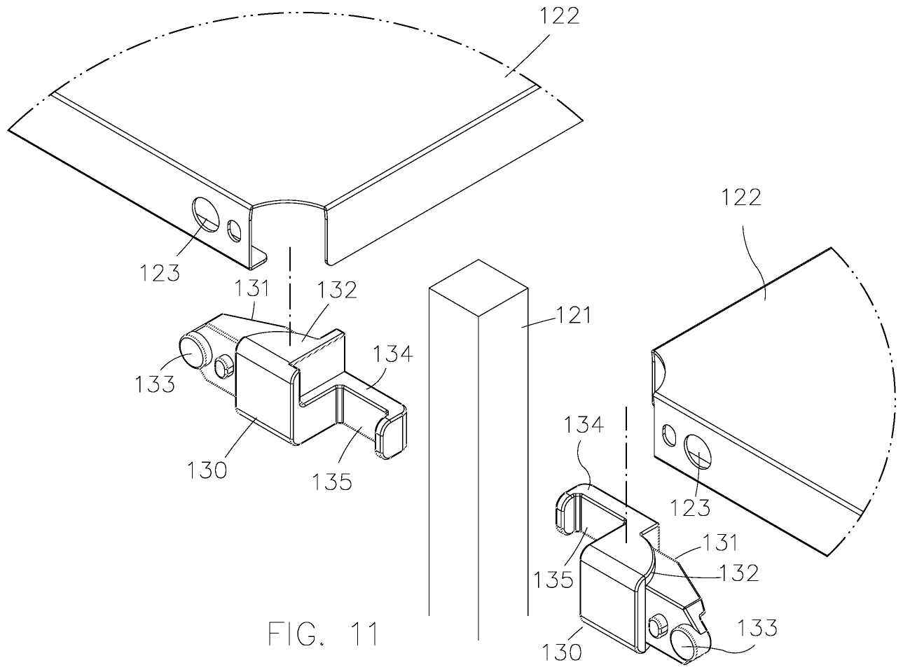

Please from FIG. 7 to FIG. 11, according to the design of the buckling hook part (32) of the combining hook (30) being formed in the half-thickness status and the combining hooks (30) combined at the two distal corner parts of the layer plate (20) being oppositely arranged provided by the present invention, when the layered frame (10) is horizontally combined for a purpose of expansion, the buckling hook parts (32) of the combining hooks (30) of adjacent layered frames (20) are able to be complementary in a vertical direction, thereby enabling an expanding operation to be completed; moreover, the combining part (31) of the combining hook (30) can be designed in various structural statuses for allowing the combining hook (30) to be combined at the four distal corner parts of a metal-state layer plate, an iron-rod layer plate, a wooden-state layer plate or a glass-state layer plate, as disclosed in the first embodiment, the metal-state layer plate (20) is adopted for allowing the combining hook (30) to be combined; FIG. 7 discloses the second embodiment of the present invention, a combining hook (50) is designed for matching with a wooden-state layer plate (40), a combining part (51) of the combining hook (50) is formed with a rack slot (52) capable of being respectively received and clamped at distal corner parts of the wooden-state layer plate (40), and a predetermined location thereof is protruded with an insertion column (53) used for being matched with an insertion hole (41) preformed on a lateral side of the wooden-state layer plate (40), thereby allowing the two components to be in an inserting status for connection, and a buckling hook part (54) thereof is also designed in a half-thickness status, so that the adjacent wooden-state layer plates (40) can be complementarily buckled and hooked for combination; FIG. 8 discloses the third embodiment of the present invention, a combining hook (70) is designed for being matched with a glass-state layer plate (60), because the glass-state layer plate (60) is composed of a metal frame (61) and a glass plate (62), a combining part (71) of the combining hook (70) is formed with a rack slot (72) capable of being respectively received and clamped at distal corner parts of the metal frame (61), and a predetermined location thereof is protruded with an insertion column (73) used for being matched with an insertion hole (63) preformed on a lateral side of the metal frame (61), thereby allowing the two components to be in an inserting status for connection, and a buckling hook part (74) thereof is also designed in a half-thickness status, so that the adjacent glass-state layer plates (60) can be complementarily buckled and hooked for combination; FIG. 9 discloses the fourth embodiment of the present invention, a combining hook (90) is designed for being matched with an iron-rod layer plate (80), a combining part (91) of the combining hook (90) is formed with a buckle slot (92) capable of being respectively buckled and clamped at two side rods (81) of the iron-rod layer plate (80), and a predetermined location thereof is formed with an insertion hole (93) allowing a distal end of an end rod (82) of the iron-rod layer plate (80) to be inserted, so that the iron-rod layer plate (80) and the combining hook (90) can be buckled and combined, and a buckling hook part (94) thereof is also designed in a half-thickness status, so that the adjacent iron-rod layer plates (80) can be complementarily buckled and hooked for combination; FIG. 10 discloses the fifth embodiment of the present invention, a combining hook (110) is designed for being matched with a metal-state layer plate (100), a combining part (111) of the combining hook (110) is formed with a buckle slot (112) capable of being respectively buckled and clamped at buckle slots (112) at distal ends of the metal-state layer plate (100), and a predetermined location thereof is formed with a penetrated hole (113), so that after the metal-state layer plate (100) and the combining hook (110) are buckle and combined, a screw bolt set (101) is provided for locking so as to maintain the combining relation, and a buckling hook part (114) thereof is also designed in a half-thickness status, so that the adjacent metal-state layer plates (100) can be complementarily buckled and hooked for combination; FIG. 11 discloses the sixth embodiment of the present invention, a combining hook (130) is designed for being matched with a layered frame (120) having a rectangular frame rod (121), a combining part (131) of the combining hook (130) is designed to be respectively mounted at distal ends of a metal-sheet layered frame (122), and the combining part (131) is formed with an abutting part (132) capable of being respectively matched and abutted against distal parts of the metal-sheet layered frame (122), and formed with convex columns (133) corresponding to through holes (123) preformed on a lateral surface defined at an end corner part of the metal-sheet layered frame (122), so that the two above-mentioned components can be inserted for connection, and a buckling hook part (134) thereof is also designed in a half-thickness status, a hook slot (135) of the buckling hook parts (134) is designed for being matched with the status of the rectangular-rod frame rod (121), so that the adjacent metal-sheet layered frames (122) can be complementarily buckled and hooked for combination.

According to the combining and expanding structure of the layered frame provided by the present invention, with the buckling hook part of the combining hook respectively combined at the four distal corner parts of the layer plate being designed in the half-thickness status, the combining part of the combining hook can be designed with respect to different assembling statuses of the layer plates made of different materials, the combining hooks arranged at the left side and the right side of the layer plate are oppositely arranged, so that when a requirement of the layered frame being desired to be horizontally expanded and combined, the operation of combining and expanding the layered frame can be easily finished through additionally providing a set of frame rods and a plurality of layer plates, and the existed assembling relation and the operation status of the layered frame are totally prevented from being affected; as such, the combining and expanding structure of the layered frame provided by the present invention is novel and more practical in use comparing to prior art.

Based on what has been disclosed above, in the combining and expanding structure of the layered frame provided by the present invention, with the novel structural design, when the specification of the layered frame is desired to be expanded, only one set of lateral frames is required without breaking the principle of not affecting the assembling operation and the operating status of the existed layered frame, the combining hooks arranged at two distal corner parts of the layer plate are oppositely arranged, so that the additional layer plate can be buckled and assembled between the lateral frame of the existed layered frame and the newly-added lateral frame, the buckling hook parts of the combining hooks of the adjacent layer plates can be complementarily stacked, thereby achieving an objective of combining and expanding the layered frame; as such, the combining and expanding structure of the layered frame provided by the present invention is novel and more practical in use comparing to prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A combining and expanding structure of a layered frame, the layered frame including a single-rod frame rod and a plurality of layer plates, a combining hook being respectively combined at four distal corner parts of the layer plate, the combining hook being provided with a buckling hook part capable of being buckled with a rod body of a frame rod, wherein:
each of the combining hook includes a combining part capable of being respectively combined at the four distal corner parts of the layer plate, and a buckling hook part integrally extended from one side of the combining part; the combining part of the combining hook is designed to be formed with different structural statuses with respect to the layer plate made of different materials and types, the buckling hook part of the combining hook is designed in a half-thickness status, a hook slot thereof is formed in a non-arched polygonal status with respect to the frame rod of the layered frame, when the combining hook is assembled at the four distal corner parts of the layer plate, the combining hooks at two sides are oppositely arranged, so that the buckling hook parts of the combining hooks at the two sides of the layer plate are in a staggering status in a vertical direction, when the horizontal specification of the layered frame is desired to be expanded, only one set of lateral frame is required for enabling the desired layer plate to be buckled and assembled between the lateral frame rod of the existing layered frame and the new lateral frame rod, and the buckling hook parts of the combining hooks of the adjacent layer plates are able to be complementarily stacked, thereby achieving an objective of combining and expanding the layered frame.

2. The combining and expanding structure of the layered frame as claimed in claim 1, wherein the combining part of the combining hook has an abutting part engaged at a top edge and a bottom edge of a base part of the buckling hook part and capable of matching and abutting against four distal corner arc-shaped notches of the layer plate, so as to achieve a stably fastening effect, an outer circumference of the combining part is formed with convex mounting columns corresponding to penetrated holes preformed on a lateral surface defined on one distal corner part of the layer plate, with the convex mounting columns working with the abutting part, the combining hook is able to be stably combined at the four distal corner parts of the metal layer plate.

3. The combining and expanding structure of the layered frame as claimed in claim 1, wherein the combining part of the combining hook is formed with a rack slot capable of being respectively received and clamped at distal corner parts of a wooden-state layer plate (or a metal frame of a glass-state layer plate), and a predetermined location thereof is protruded with an insertion column used for being matched with an insertion hole preformed on a lateral side of the wooden-state layer plate (or the metal frame of the glass-state layer plate), thereby allowing the two components to be in an inserting status for connection.

4. The combining and expanding structure of the layered frame as claimed in claim 1, wherein the combining part of the combining hook is formed with a buckle slot capable of being respectively buckled and clamped at two side rods of an iron-rod layer plate, and a predetermined location thereof is formed with an insertion hole allowing a distal end of an end rod of the iron-rod layer plate to be inserted, so that the iron-rod layer plate and the combining hook are able to be buckled and combined.

5. The combining and expanding structure of the layered frame as claimed in claim 1, wherein the combining part of the combining hook is formed with a buckle slot capable of being respectively buckled and clamped at distal ends of a metal-state layer plate, and a predetermined location thereof is formed with a penetrated hole, so that after the metal-state layer plate and the combining hook are buckle and combined, a screw bolt set is provided for locking so as to maintain the combining relation.
